(19) United States
(12) Patent Application Publication
(10) Pub. No.: US 2019/0229403 A1
(43) Pub. Date: Jul. 25, 2019

(54) ANTENNA SYSTEM AND COMMUNICATION TERMINAL

(71) Applicant: AAC Technologies Pte. Ltd., Singapore City (SG)

(72) Inventors: Zhengdong Yong, Shenzhen (CN); Wei Zhao, Shenzhen (CN); Xiaoyue Xia, Shenzhen (CN); Chao Wang, Shenzhen (CN)

(21) Appl. No.: 16/236,511

(22) Filed: Dec. 30, 2018

(30) Foreign Application Priority Data
Jan. 25, 2018 (CN) 201810070582.9

(51) Int. Cl. H01Q 1/24; H01Q 1/48; H01Q 21/22; H04W 16/28; H01Q 3/36; H01Q 21/06

(52) U.S. Cl. CPC H01Q 1/243; H01Q 1/48; H01Q 21/065; H04W 16/28; H01Q 3/36; H01Q 21/22

(57) ABSTRACT

The present disclosure provides an antenna system, including a system ground unit and a millimeter wave antenna array, where four millimeter wave antenna arrays respectively disposed on a front side and a rear side of the system ground unit are included, and every two of the millimeter wave antenna arrays are disposed on the same side of the system ground unit; each of the millimeter wave antenna arrays includes a plurality of antenna units arranged in a linear array and a plurality of phase shifters electrically connected to the plurality of antenna units; the two millimeter wave antenna arrays located on the front side of the system ground unit are disposed parallel to each other and both extend along a first direction; The antenna system and the communication terminal of the present disclosure have a high gain, high coverage efficiency, and a stable signal.

### CROSS-REFERENCE TO RELATED APPLICATIONS

This application claims the priority benefit of Chinese Patent Applications Ser. No. 201810070582.9 filed on Jan. 25, 2018, the entire content of which is incorporated herein by reference.

### TECHNICAL FIELD

The present disclosure relates to an antenna, and in particular, to an antenna system and a communication terminal that are applied to communication electronic products.

### BACKGROUND

With the development of mobile communication technologies, mobile phones, PADs, notebook computers, and the like have gradually become important electronic products in life, and such electronic products have been updated to include an antenna system and therefore become electronic communication products having a communication function.

As the focus of research and development in the global industry, 5G has three main application scenarios: enhanced mobile broadband, large-scale machine communication, and high-reliability and low-latency communication. The three application scenarios respectively correspond to different key indicators, where a user peak velocity in the enhanced mobile broadband scenario is 20 Gbps, and a minimum user experience rate is 100 Mbps. A high carrier frequency and large bandwidth characteristic unique to millimeter waves is a main means to achieve a 5G ultra-high data transmission rate. Therefore, rich bandwidth resources of a millimeter wave frequency band provide a guarantee for the high-speed transmission rate.

However, due to severe spatial loss of electromagnetic waves in the millimeter wave frequency band, a wireless communication system using the millimeter wave frequency band needs to use a phased array architecture. Phases of array elements are distributed according to a particular rule by using a phase shifter, so that a high-gain beam is formed, and the beam is enabled, through a phase shift change, to scan within a particular space. A scanning coverage of a single phased array antenna is usually less than a hemisphere. If a communication terminal such as a mobile phone uses an antenna system in a form of a single array, a problem that a signal is unstable may be caused.

Therefore, it is necessary to provide a new antenna system and a communication terminal to resolve foregoing problems.

### BRIEF DESCRIPTION OF THE DRAWINGS

To illustrate the technical solutions in the embodiments of the present disclosure more clearly, the following briefly describes the accompanying drawings required for describing the embodiments. Apparently, the accompanying drawings in the following descriptions merely show some embodiments of the present disclosure, and persons of ordinary skill in the art can derive other drawings from these accompanying drawings without creative efforts.

FIG. 1a and FIG. 1b are schematic structural diagrams of an antenna system according to the present disclosure;

FIG. 2 is a schematic structural diagram of a millimeter wave antenna array of an antenna system according to the present disclosure;

FIG. 3 is a schematic diagram of a beam tilting direction of the millimeter wave antenna array in FIG. 2 when each antenna unit is fed in equal amplitude and same phase;

FIG. 4 is a beam tilting directivity pattern of a millimeter wave antenna array 1 in an XZ plane when each antenna unit is fed in equal amplitude and same phase;

FIG. 5 is a beam tilting directivity pattern of a millimeter wave antenna array 2 in an XZ plane when each antenna unit is fed in equal amplitude and same phase;

FIG. 6 is a beam tilting directivity pattern of a millimeter wave antenna array 3 in a YZ plane when each antenna unit is fed in equal amplitude and same phase;

FIG. 7 is a beam tilting directivity pattern of a millimeter wave antenna array 4 in a YZ plane when each antenna unit is fed in equal amplitude and same phase;

FIGS. 8a to 8e are divisional scanning mode effect diagrams and overall scanning mode effect diagrams of four millimeter wave antenna arrays of an antenna system according to the present disclosure;

FIG. 9 is a curve diagram of frequency coverage efficiency of an antenna system according to the present disclosure; and

FIGS. 10a and 10b are schematic structural diagrams of a communication terminal according to the present disclosure.

### DETAILED DESCRIPTION

The technical solutions of the embodiments of the present disclosure are illustrated clearly and completely in the following with reference to the accompanying drawings in the embodiments of the present disclosure. Apparently, the illustrated embodiments are only some embodiments of the present disclosure, rather than all embodiments. On the basis of the embodiments of the present disclosure, all other embodiments obtained by persons of ordinary skill in the art without creative efforts shall fall within the protection scope of the present disclosure.

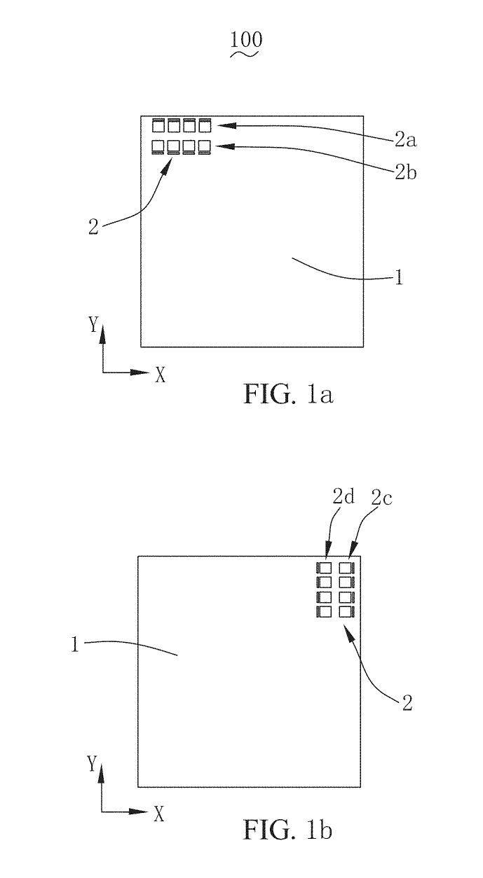

FIG. 1a and FIG. 1b are schematic structural diagrams of an antenna system according to the present disclosure. FIG. 1a is a schematic structural diagram of a front side of the structure of the antenna system, and FIG. 1b is a schematic structural diagram of a rear side of the structure of the antenna system. The present disclosure provides an antenna system 100, including a system ground unit 1 and a millimeter wave antenna array 2.

There are four millimeter wave antenna arrays 2 respectively disposed on a front side and a rear side of the system ground unit 1, and every two of the millimeter wave antenna arrays 2 are disposed on the same side of the system ground unit 1. Specifically, the four millimeter wave antenna arrays 2 are respectively a first millimeter wave antenna array 2a, a second millimeter wave antenna array 2b, a third millimeter wave antenna array 2c, and a fourth millimeter wave antenna array 2d.

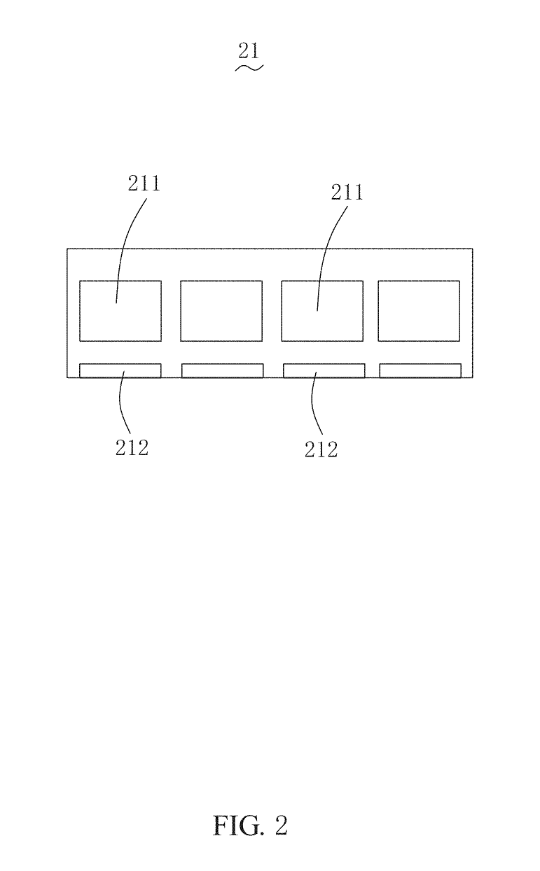

FIG. 2 is a schematic structural diagram of a millimeter wave antenna array of an antenna system according to the present disclosure. Each of the millimeter wave antenna arrays 2 includes a plurality of antenna units 21 arranged in a linear array and a plurality of phase shifters (not shown) electrically connected to the plurality of antenna units 21.

In this embodiment, the antenna unit 21 is a beam tilting patch antenna, and space occupied by the antenna unit 21 can be reduced. Certainly, the present disclosure is not limited to this type of antenna.

A specification of the phase shifter 22 is 5 bits, and phase shift precision of the phase shifter 22 is 11.25°.

The millimeter wave antenna array 2 is arranged in a linear array, rather than a planar array. On one hand, space occupied by the millimeter wave antenna array 2 is narrowed, and only one angle needs to be scanned, so that the designing difficulty, testing difficulty, and beam management complexity are reduced. On the other hand, because beam tilting can be performed in a non-scanning direction, spatial coverage of the antenna system 100 of the array can be managed more flexibly.

In this embodiment, specifically, each of the millimeter wave antenna arrays 2 includes four antenna units 21 and four phase shifters electrically connected to the four antenna units 21.

In other embodiments, the phase shifter may be of another specification, and is not limited to 5 bits.

Each of the antenna units 21 includes a radiator 211 and a director 212 spaced away from the radiator 211 and configured to implement beam tilting. The radiator 211 is coupled to the director 212, and the radiator 211 is connected to an external power supply to implement feeding.

The two millimeter wave antenna arrays 2 located on the front side of the system ground unit 1 are disposed parallel to each other and both extend along a first direction; the two millimeter wave antenna arrays 2 located on the rear side of the system ground unit 1 are disposed parallel to each other and both extend along a second direction. The first direction is perpendicular to the second direction; and the four millimeter wave antenna arrays 2 jointly form omnidirectional coverage. For example, the first direction is a horizontal direction, and the second direction is a vertical direction.

In this embodiment, for example, the system ground unit 1 is rectangular. The first direction is a short-axis direction of the system ground unit 1, and the second direction is a long-axis direction of the system ground unit 1.

Specifically, the first millimeter wave antenna array 2a and the second millimeter wave antenna array 2b are located on the front side of the system ground unit 1, are parallel to each other, and both extend along the first direction (short-axis direction) of the system ground unit 1. The third millimeter wave antenna array 2c and the fourth millimeter wave antenna array 2d are located on the rear side of the system ground unit 1, are parallel to each other, and both extend along the second direction (long-axis direction) of the system ground unit 1.

More preferably, the two millimeter wave antenna arrays 2 located on the front side of the system ground unit 1 (the first millimeter wave antenna array 2a and the second millimeter wave antenna array 2b) are disposed opposite to the two millimeter wave antenna arrays 2 located on the rear side of the system ground unit 1 (the third millimeter wave antenna array 2c and the fourth millimeter wave antenna array 2d).

The four millimeter wave antenna arrays 2 may be disposed at the same corner of the system ground unit 1. In this case, the four millimeter wave antenna arrays 2 may share one processor, and have a short connection line and small signal loss.

Certainly, the four millimeter wave antenna arrays 2 may alternatively be disposed at different corners. For example, the two millimeter wave antenna arrays 2 located on the front side of the system ground unit 1 (the first millimeter wave antenna array 2a and the second millimeter wave antenna array 2b) are disposed at the upper left corner of the front side, and the two millimeter wave antenna arrays 2 located on the rear side of the system ground unit 1 (the third millimeter wave antenna array 2c and the fourth millimeter wave antenna array 2d) are disposed at the upper right corner of the rear side.

The foregoing arrangement manner enables the four millimeter wave antenna arrays 2 to be densely distributed on the front side and the rear side of the system ground unit 1, and reduces line loss from an RFFE to each of the antenna units 21, thereby improving receiving efficiency of the antenna system 100.

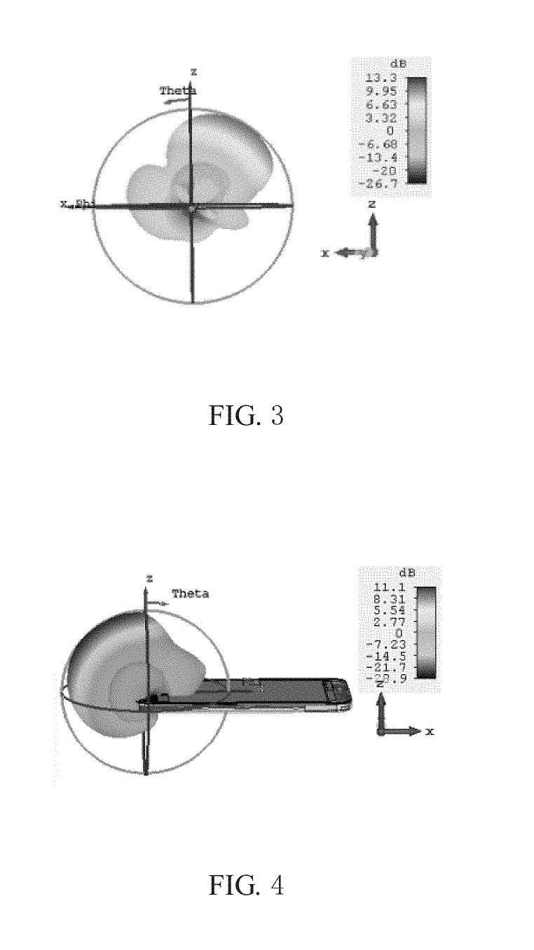

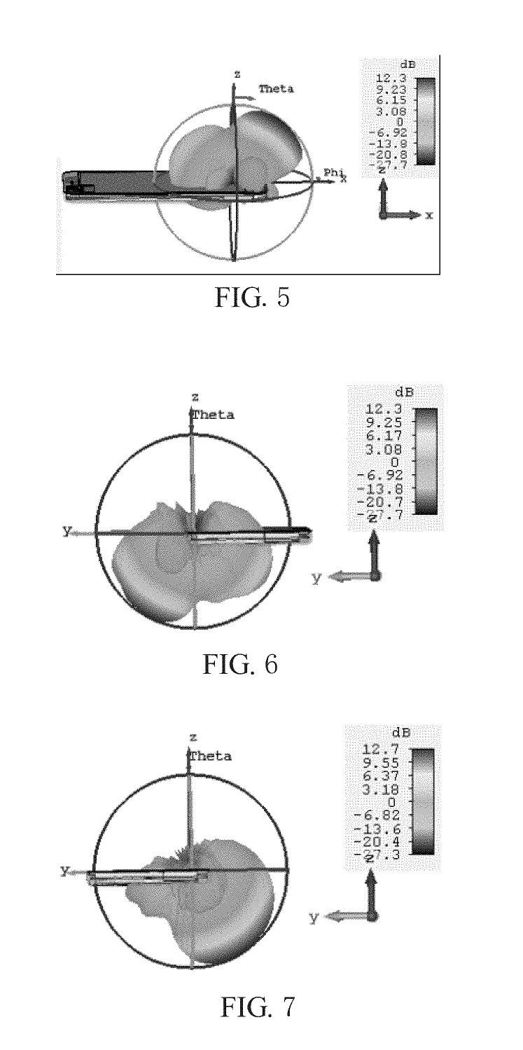

Referring to FIG. 3 to FIG. 7, using an example in which the system ground unit 1 is of a rectangular flat structure, the long-axis direction of the system ground unit 1 is defined as the X-axis direction, the short-axis direction of the system ground unit 1 is defined as the Y-axis direction, and a direction perpendicular to a plane formed by the X axis and the Y axis is a Z-axis direction. A beam tilting directivity pattern of the first millimeter wave antenna array 2a, the second millimeter wave antenna array 2b, the third millimeter wave antenna array 2c, and the fourth millimeter wave antenna array 2d of the antenna system 100 of the present disclosure when a phase shift is 0 can be obtained.

Space is divided into six blocks, which are respectively +X (rear), −X (front), +Z (upper), −Z (lower), +Y (left), and −Y (right) spaces of the system ground unit 1. Using an example in which the antenna unit 21 is a beam tilting patch antenna, simulation is performed by using a simulator. By means of a phase shift change of the phase shifter, the first millimeter wave antenna array 2a and the second millimeter wave antenna array 2b cover the +Z and ±X spaces of the system ground unit 1, and the third millimeter wave antenna array 2c and the fourth millimeter wave antenna array 2d cover the −Z and ±Y spaces of the system ground unit 1. That is, full-range coverage of the space is implemented.

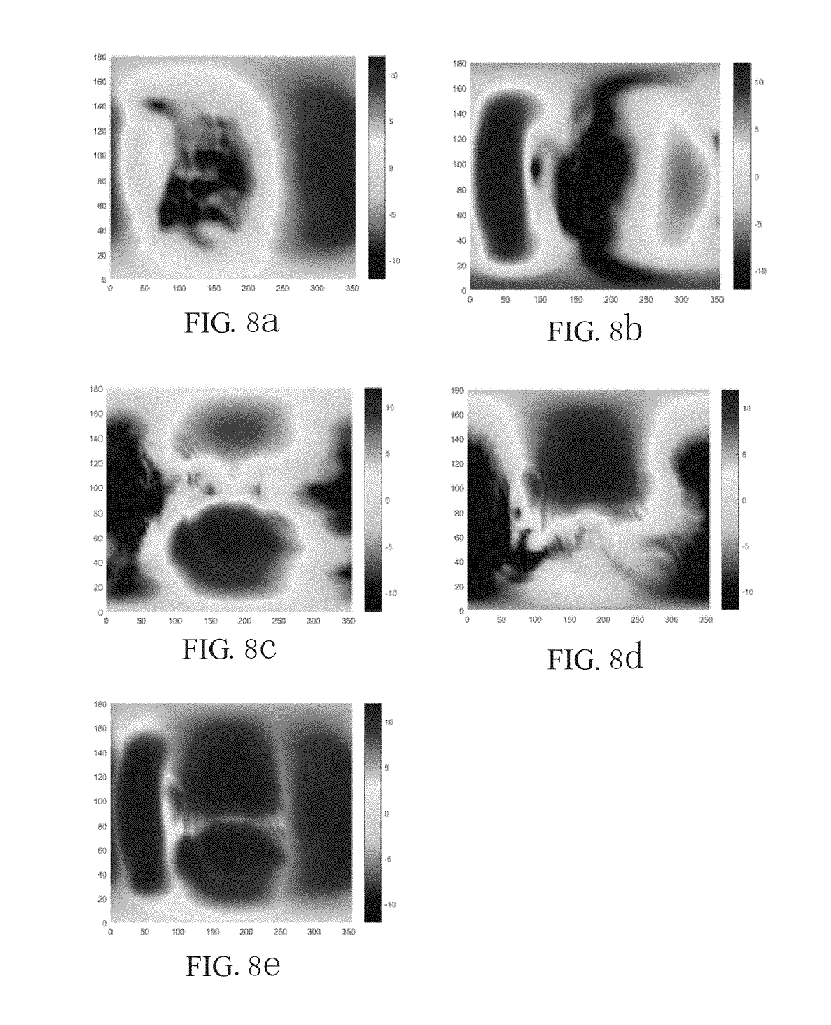

FIG. 8a-8e are divisional scanning mode effect diagrams and overall scanning mode effect diagrams of four millimeter wave antenna arrays of an antenna system according to the present disclosure. As can be learned from the figure, FIG. 8a, FIG. 8b, FIG. 8c, and FIG. 8d respectively show scanning modes in different directions, and FIG. 8e shows jointly implementing an omnidirectional scanning mode.

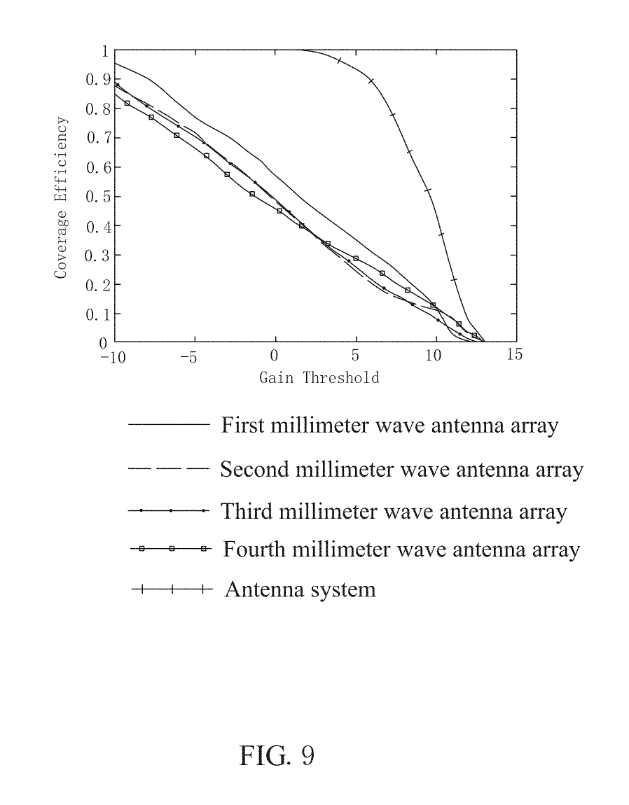

FIG. 9 is a curve diagram of frequency coverage efficiency of an antenna system according to the present disclosure, where the abscissa represents a gain threshold, and the ordinate represents coverage efficiency, and a unit of the abscissa is dB. As can be learned from the figure, frequency coverage efficiency of the first millimeter wave antenna array 2a, the second millimeter wave antenna array 2b, the third millimeter wave antenna array 2c, and the fourth millimeter wave antenna array 2d in a single structure is ordinary, but after the foregoing array arrangement is formed through combination, the overall frequency coverage efficiency of the antenna system 100 is improved to the greatest extent.

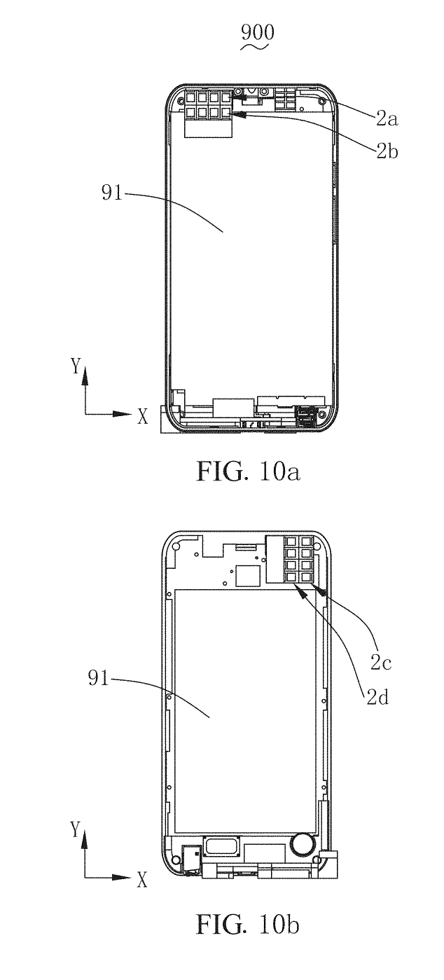

FIGS. 10a and 10b are schematic structural diagrams of a communication terminal according to the present disclosure. The present disclosure also provides a communication terminal 900, including a main board 91 and the antenna system 100 provided in the present disclosure, where the main board 91 serves as the system ground unit.

The communication terminal may be a mobile electronic product such as a mobile phone or an IPAD. Using a mobile phone as an example, when the mobile phone uses the antenna system 100, the first millimeter wave antenna array 2a and the second millimeter wave antenna array 2b cover the +Z and ±X spaces of the mobile phone, and the third millimeter wave antenna array 2c and the fourth millimeter wave antenna array 2d cover the −Z and ±Y spaces of the mobile phone 1. That is, full-range coverage of the space of the mobile phone is implemented.

Compared with the existing art, in the antenna system of the present disclosure, a plurality of millimeter wave antenna arrays fed by a coaxial probe is used, and a structure having a high-gain beam is arranged; the millimeter wave antenna arrays are designed to be linear arrays, occupy small space, and need to scan only one angle, so that the designing and testing difficulties are reduced, and spatial coverage of the antenna system can be managed more flexibly, thereby implementing full-range coverage and achieving high stability. The millimeter wave antenna arrays are distributed on two sides of the system ground in a relatively dense manner, and form a layout according to a particular rule, so that line loss from the RFFE to the antenna unit is reduced, and receiving efficiency is improved. The communication terminal using the antenna system has a strong and stable communication signal, wide frequency band coverage, and high receiving and transmitting efficiency.

The foregoing descriptions are merely embodiments of the present disclosure, and the protection scope of the present disclosure is not limited thereto. All equivalent structure or process changes made according to the content of this specification and accompanying drawings in the present disclosure or by directly or indirectly applying the present disclosure in other related technical fields shall fall within the protection scope of the present disclosure.

What is claimed is:

1. An antenna system, comprising
a system ground unit; and
millimeter wave antenna arrays;
wherein the antenna system comprises four millimeter wave antenna arrays respectively disposed on a front side and a rear side of the system ground unit, and every two of the four millimeter wave antenna arrays are disposed on the same side of the system ground unit;
each of the millimeter wave antenna arrays comprises a plurality of antenna units arranged in a linear array and a plurality of phase shifters electrically connected to the plurality of antenna units;
the two millimeter wave antenna arrays located on the front side of the system ground unit are parallel to each other and both extend along a first direction; the two millimeter wave antenna arrays located on the rear side of the system ground unit are parallel to each other and both extend along a second direction; the first direction is perpendicular to the second direction; and
the four millimeter wave antenna arrays jointly form omnidirectional coverage.

2. The antenna system according to claim 1, wherein each of the millimeter wave antenna arrays comprises four antenna units and four phase shifters electrically connected to the four antenna units.

3. The antenna system according to claim 1, wherein the antenna unit comprises a radiator and a director spaced away from the radiator and configured to implement beam tilting, and the radiator is coupled to the director.

4. The antenna system according to claim 2, wherein a specification of the phase shifter is 5 bits, and phase shift precision of the phase shifter is 11.25°.

5. The antenna system according to claim 1, wherein the first direction is a short-axis direction of the system ground unit, and the second direction is a long-axis direction of the system ground unit.

6. The antenna system according to claim 1, wherein the two millimeter wave antenna arrays located on the front side of the system ground unit are opposite to the two millimeter wave antenna arrays located on the rear side of the system ground unit.

7. The antenna system according to claim 6, wherein the system ground unit is of a rectangular structure, the two millimeter wave antenna arrays located on the front side of the system ground unit are disposed at the upper left corner of the front side, and the two millimeter wave antenna arrays located on the rear side of the system ground unit are disposed at the upper right corner of the rear side.

8. The antenna system according to claim 1, wherein the antenna unit is a beam tilting patch antenna.

9. A communication terminal, comprising a main board and the antenna system according to claim 1, wherein the main board serves as the system ground unit.

10. A communication terminal, comprising a main board and the antenna system according to claim 2, wherein the main board serves as the system ground unit.

11. A communication terminal, comprising a main board and the antenna system according to claim 3, wherein the main board serves as the system ground unit.

12. A communication terminal, comprising a main board and the antenna system according to claim 4, wherein the main board serves as the system ground unit.

13. A communication terminal, comprising a main board and the antenna system according to claim 5, wherein the main board serves as the system ground unit.

14. A communication terminal, comprising a main board and the antenna system according to claim 6, wherein the main board serves as the system ground unit.

15. A communication terminal, comprising a main board and the antenna system according to claim 7, wherein the main board serves as the system ground unit.

16. A communication terminal, comprising a main board and the antenna system according to claim 8, wherein the main board serves as the system ground unit.
